(19) United States
(12) Patent Application Publication
(10) Pub. No.: US 2016/0195608 A1
(43) Pub. Date: Jul. 7, 2016

(54) DEVICE AND METHOD FOR ASCERTAINING A PROPERTY OF AN OBJECT

(71) Applicant: Robert Bosch GmbH, Stuttgart (DE)

(72) Inventor: Johannes Ruenz, Renningen (DE)

(21) Appl. No.: 14/987,870

(22) Filed: Jan. 5, 2016

(30) Foreign Application Priority Data
Jan. 5, 2015 (DE) 10 2015 200 014.1

(51) Int. Cl. G01S 7/41; G01S 13/93

(52) U.S. Cl. CPC G01S 7/411; G01S 13/93

(57) ABSTRACT

A device and a method for ascertaining a property of an object includes: emitting a first electromagnetic wave having a first frequency within a first frequency range for the at least partial reflection at the object as a first reflected electromagnetic wave; emitting a second electromagnetic wave having a second frequency within a second frequency range for the at least partial reflection at the object as a second reflected electromagnetic wave, the first and the second frequency range being disjunct; generating a first measurement signal based on the received first reflected electromagnetic wave; generating a second measurement signal based on a received second reflected electromagnetic wave; and analyzing the first measurement signal and the second measurement signal to ascertain the property of the object.

### RELATED APPLICATION INFORMATION

The present application claims priority to and the benefit of German patent application no. 10 2015 200 014.1, which was filed in Germany on Jan. 5, 2015, the disclosure of which is incorporated herein by reference.

### FIELD OF THE INVENTION

The present invention relates to a device and to a method for ascertaining a property of an object. A property of an inject in particular means a property of the object's material. By ascertaining the material property, the object can be classified into one of the classes of “metal”, “human being”, “concrete”, “water”, etc., for example.

### BACKGROUND INFORMATION

Sensor systems for sensing an environment, for instance in the automotive sector, are believed to be based on a sensor system of electromagnetic waves and ultrasound technology. To classify objects, such as road users, e.g., vehicles or persons, the dynamic behavior and the reflecting cross-section of radar waves emitted by a radar device in the radar range are analyzed. In optical systems, the magnitude, dynamic behavior and specific geometric features of the object to be classified are detected or ascertained and used for the object classification.

The publication U.S. Pat. No. 7,948,429 B2 discusses a method and a device for detecting and classifying radar targets. The method includes the receiving of radar echoes in a low beam receiver channel and a high beam receiver channel, an altitude information about a radar target being generated on the basis of a target amplitude ratio between the low beam receiver channel and the high beam receiver channel, and differential reflectivity and phase data are ascertained and analyzed in order to classify the radar target.

### SUMMARY OF THE INVENTION

The present invention discloses a device having the features described herein, and a method having the features described herein.

Accordingly, the present invention provides a device for ascertaining a property of an object, the device encompassing a transmitter device, by which a first electromagnetic wave having a first frequency spectrum within a first frequency range is able to be emitted for an at least partial reflection at the object as a first reflected electromagnetic wave; and by which a second electromagnetic wave having a second frequency spectrum within a second frequency range is able to be emitted for an at least partial reflection at the object as a second reflected electromagnetic wave, the first and the second frequency range being disjunct; a receiver device, by which the first and the second reflected electromagnetic wave are able to be received and by which a first measurement signal can be generated based on the received first reflected electromagnetic wave, and a second measurement signal can be generated based on the received second reflected electromagnetic wave; and an evaluation circuit for ascertaining a property of the object on the basis of the first measurement signal and the second measurement signal.

A frequency spectrum in particular describes amplitudes and/or phases for one frequency or multiple frequencies, or frequency peaks within a frequency range. Accordingly, the frequency spectrum, for instance, may be a monochromatic frequency peak or a Gauss-type frequency distribution. The statement that the first and the second frequency range are disjunct means that there is no frequency that lies both in the first and the second frequency range.

Moreover, the present invention provides a method for ascertaining a property of an object, the method comprising the following steps: Emitting a first electromagnetic wave having a first frequency within a first frequency range for the at least partial reflection at the object as a first reflected electromagnetic wave; emitting a second electromagnetic wave having a second frequency within a second frequency range for the at least partial reflection at the object as a second reflected electromagnetic wave, the first and the second frequency range being disjunct; generating a first measurement signal based on a received first reflected electromagnetic wave; generating a second measurement signal based on a received second reflected electromagnetic wave; analyzing the first measurement signal and the second measurement signal in order to ascertain the property of the object.

The realization that forms the basis of the present invention is that different objects cause frequency-specific changes, such as in the amplitude and the phase, in electromagnetic waves that are impinging on objects and are reflected by the objects. As a result, it is possible to ascertain properties of the reflecting objects, in particular material properties, and thus to classify objects in the environment of the device.

The idea on which the present invention is based now is to take this recognition into account and to provide a device which allows an especially precise determination of the properties of objects by ascertaining and comparing properties of reflected electromagnetic waves that were generated by emitted electromagnetic waves having frequencies in at least two frequency ranges that are disjunct from one another.

The inventive device is advantageously able to be installed in or on a vehicle, so that objects in an environment of the vehicle are ascertainable at least with regard to one property. A vehicle in particular means a road vehicle, a rail vehicle, a watercraft or an airplane.

The fact that electromagnetic waves having frequencies of the two disjunct frequency ranges are emitted provides a further classification feature, for instance in comparison with conventional radar devices, so that the accuracy of an object classification is able to be improved. The inventive device, for example, may be used as part of an emergency braking and/or collision avoidance system. Furthermore, a different classification is possible of material properties of two objects which do reflect the same radiation output of the electromagnetic waves emitted by the inventive device, but result in different frequency spectra of the reflected electromagnetic waves.

Advantageous embodiments and refinements result from the dependent claims and from the specification with reference to the drawing.

According to one specific embodiment, the first measurement signal indicates a first spectroscopic property of the received first reflected electromagnetic wave, and the second measurement signal indicates a second spectroscopic property of the received second reflected electromagnetic wave. A spectroscopic property of an electromagnetic wave in particular means one or more parameter(s) of a frequency spectrum. The spectroscopic property thus may be a position, a maximum amplitude and/or a width of a frequency peak of the frequency spectrum, an integrated radiant power of the frequency spectrum, a width of the frequency spectrum, etc.

According to one specific embodiment, the evaluation device is configured for comparing the first spectroscopic property to the first frequency spectrum or a frequency spectrum derived from the first frequency spectrum in a first comparison, based on the first measurement signal. According to one further specific embodiment, the evaluation device is configured for comparing the second spectroscopic property to the second frequency spectrum or a frequency spectrum derived from the second frequency spectrum in a second comparison, based on the second measurement signal. As an alternative or in addition, in the first or the second comparison the first frequency spectrum and/or the second frequency spectrum may also be compared to one or a plurality of predefined reference spectrum/spectra stored in the evaluation device.

A frequency spectrum derived from an original frequency spectrum in particular means that the derived frequency spectrum is obtained from the original frequency spectrum via predefined computational steps, which the evaluation device is able to execute or is executing. For instance, it may be stored in the evaluation device that the derived frequency spectrum is to be calculated from the original frequency spectrum by reducing all amplitudes of the original frequency spectrum by a relative or an absolute value, or that the derived frequency spectrum is to be calculated from the original frequency spectrum through folding using a predefined function. Known interference factors such as Doppler shifts, and environmental influences can be filtered out in this way, so that the property of the object is ascertainable even more precisely.

According to one further specific embodiment, the evaluation device is configured for ascertaining the property of the object based on the result of the first and the second comparison.

According to one specific embodiment, the evaluation device is set up for comparing the result of the first comparison with the result of the second comparison in a third comparison, and for ascertaining the property of the object based on the result of the third comparison. For example, the result of the first comparison may be a first absorption factor, and the result of the second comparison a second absorption factor, and the result of the third comparison is a numerical comparison of the first absorption factor with the second absorption factor. It is possible to use the evaluation device for ascertaining that the object has a first property, e.g., the property of being of metal, if the first absorption factor is greater than the second absorption factor, and to furthermore determine that the object has a second property, e.g., the property of being non-metallic, if the second absorption factor is greater than the first absorption factor or equal to it.

According to one further specific embodiment, the first frequency range or the second frequency range extends from three hundred gigahertz to three terahertz, in particular from nine hundred gigahertz to two terahertz, especially particularly from one terahertz to one and a half terahertz. Electromagnetic waves in these frequency ranges are nearly completely reflected by metallic surfaces, while they are nearly completely absorbed by persons and thus are advantageously suitable for ascertaining the property of the object, be it a person or a metallic surface.

According to one further specific embodiment, the first frequency range or the second frequency range is between five hundred megahertz and one hundred gigahertz, which may be between eight hundred megahertz and two gigahertz. Using electromagnetic waves in this frequency range makes it possible to detect people behind walls, for instance. In the same way, the first frequency range or the second frequency range may extend between twenty and eighty megahertz, especially particularly between 23 and 28 gigahertz or between 76 and 81 gigahertz.

According to one further specific embodiment, the first and the second electromagnetic waves are emittable simultaneously. Avoiding a time offset between the emission of the first electromagnetic wave and the second electromagnetic wave makes it possible to avoid a falsification of measuring results based on a movement of the object during the time offset, for example. By emitting the first and the second electromagnetic waves having a frequency spectra in the discrete first and second frequency ranges, there is also no possibility of ambiguity of the received reflected electromagnetic waves.

According to one further specific embodiment, the first measurement signal indicates a first spectroscopic property of the received first reflected electromagnetic wave, and the second measurement signal indicates a second spectroscopic property of the received second reflected electromagnetic wave.

According to one further specific embodiment, the evaluation of the first measurement signal and the second measurement signal in the inventive method includes the following steps: In a first comparison, comparing the first spectroscopic property to the first frequency spectrum or a frequency spectrum derived from the first frequency spectrum; in a second comparison, comparing the second spectroscopic property with the second frequency spectrum or a frequency spectrum derived from the second frequency spectrum; the property of the object being ascertained based on the result of the first and the second comparisons.

According to one further specific embodiment, the evaluation of the first measurement signal and the second measurement signal in the inventive method includes the steps: Comparing the result of the comparison to the result of the second comparison in a third comparison, the property of the object being determined based on the result of the third comparison.

According to one further specific embodiment of the method of the present invention, the first and the second electromagnetic wave are emitted simultaneously.

In the following text, the present invention will be explained in greater detail with the aid of the exemplary embodiments shown in the schematic figures of the drawings.

Unless indicated otherwise, identical or functionally equivalent elements and devices have been provided with the same reference symbols. The numbering of the method steps is provided for reasons of clarity and in particular is not meant to imply a certain time sequence, unless indicated otherwise. In particular, it is also possible to carry out multiple method steps at the same time.

### BRIEF DESCRIPTION OF THE DRAWINGS

FIG. 1 shows a schematic block diagram of an inventive device for ascertaining a property of an object according to one specific embodiment of the present invention.

FIG. 2 shows a schematic block diagram of a device for ascertaining a property of an object according to one specific embodiment of the present invention.

FIG. 3 shows a schematic flow chart to explain a method for ascertaining a property of an object according to one specific embodiment of the present invention.

### DETAILED DESCRIPTION

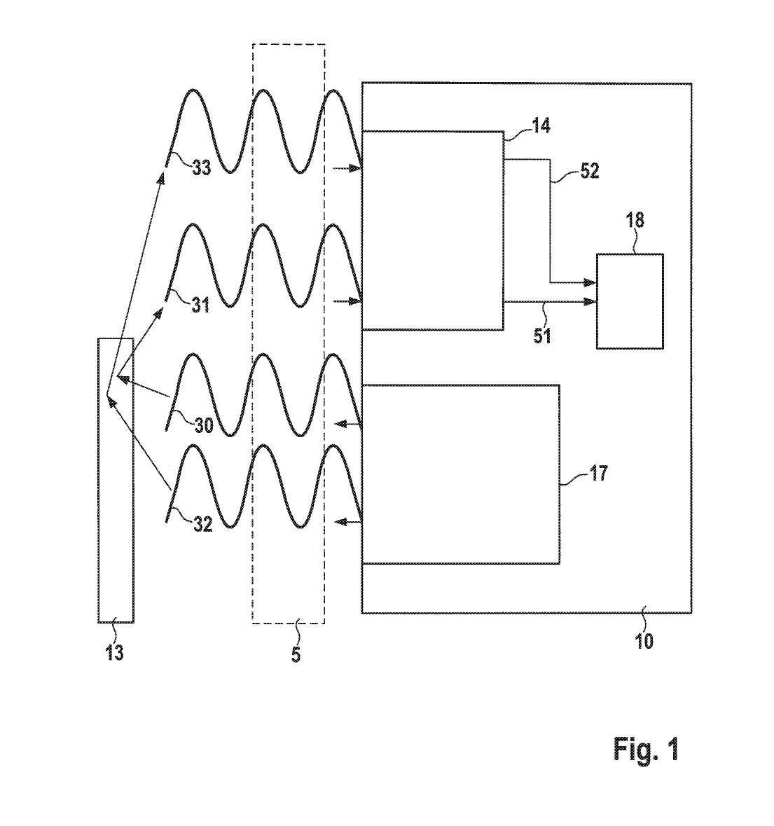

FIG. 1 shows a schematic block diagram of an inventive device 10 for ascertaining a property of an object 13 according to one specific embodiment of the present invention. Device 10 has a transmitter device 17, with the aid of which a first electromagnetic wave 30 having a first frequency spectrum within a first frequency range is able to be emitted for the at least partial reflection at object 12 through a transmission channel 5 as a first reflected electromagnetic wave 31. In other words, the particular electromagnetic wave that is produced in that the first electromagnetic wave 30 is at least partially reflected at object 13 is designated as first reflected electromagnetic wave 31.

Using transmitter device 17, a second electromagnetic wave 32 having a second frequency spectrum within a second frequency range is able to be emitted for the at least partial reflection at object 12 through transmission channel 5 as a second reflected electromagnetic wave 33. In other words, the particular electromagnetic wave that is produced in that the second electromagnetic wave 32 is at least partially reflected at object 13 by object 13 is designated as second reflected electromagnetic wave 33.

Transmission channel 5, through which first and second reflected electromagnetic waves 31, 33 are transmitted between device 10 and object 13, for example, may include or be formed by air or some other fluid such as saltwater or fresh water, but also a vacuum such as in space. A portion of transmission channel 5 may be formed by a transmissive visual obscuration, e.g., a person's clothing, wooden partitions, etc.

For example, the first frequency range ranges from 1 to 1.5 terahertz, and the second frequency ranges from 1 to 2 gigahertz. The first and second electromagnetic wave 30, 32 are emitted at the same time.

In addition, device 10 has a receiver device 14, by which first and second reflected electromagnetic waves 31, 33 are receivable. Receiver device 14 is configured to generate a first measurement signal 51 based on the received first reflected electromagnetic wave 31 and to transmit it to an evaluation unit 18 of device 10. Receiver device 14 is furthermore configured to generate a second measurement signal 52 based on the received second reflected electromagnetic wave 33 and to transmit it to an evaluation unit 18 of device 10. First measurement signal 51 indicates a first spectroscopic property of received first reflected electromagnetic wave 31, in particular a third frequency spectrum of received first reflected electromagnetic wave 31. Second measurement signal 52 indicates a second spectroscopic property of received second reflected electromagnetic wave 33, in particular a fourth frequency spectrum of received second reflected electromagnetic wave 33.

Evaluation device 18 is configured for comparing the first spectroscopic property to the first frequency spectrum of emitted first electromagnetic wave 30 or to a frequency spectrum derived from the first frequency spectrum in a first comparison.

Evaluation device 18 is also configured for comparing the second spectroscopic property to the second frequency spectrum of emitted second electromagnetic wave 32 or to a frequency spectrum derived from the second frequency spectrum in a second comparison. In particular differences are ascertained in the first and/or second comparisons, such as differences pertaining to a position or pertaining to a plurality of positions of one or more frequency peak(s), differences in amplitudes of one or a plurality of frequency peak(s), a width and/or the occurrence or non-occurrence of frequency plateaus as well as their position in the frequency space.

Evaluation device 18 is developed for ascertaining the property of object 13 to be determined, in particular the material property of object 13, on the basis of the result of the first and the second comparisons. To do so, evaluation device 18 is configured for comparing the result of the first comparison with the result of the second comparison in a third comparison and for ascertaining the property of object 13 based on the result of the third comparison.

For example, if object 13 is a person, then first electromagnetic wave 30 having the first frequency spectrum in the terahertz range is nearly completely absorbed by the person as object 13. The virtually complete absorption is able to be ascertained in that the integrated radiant power, indicated by the first measurement signal, of the third frequency spectrum of the received first reflected electromagnetic wave 31 is compared to an integrated radiant power of the first frequency spectrum of emitted first electromagnetic wave 30, the result of the first comparison being a first absorption factor, which is ascertained by dividing the integrated radiant power of the third frequency spectrum by the integrated radiant power of the first frequency spectrum.

An integrated radiant power is meant to describe the integration of a frequency-dependent radiation intensity of a particular electromagnetic wave across frequencies ranging from a first frequency value to a second frequency value. The first and the second frequency value advantageously correspond to the lowest and the highest frequency value of the particular frequency range that contains the frequency spectrum across which the integration is to take place.

In the above example where a person functions as object 13, second electromagnetic wave 30 having the second frequency spectrum in the lower gigahertz range is nearly completely reflected by object 13. The virtually complete reflection is able to be ascertained by comparing the integrated radiant power, indicated by the second measurement signal, of the fourth frequency spectrum of the received second reflected electromagnetic wave 33 to an integrated radiant power of the second frequency spectrum of emitted second electromagnetic wave 32, the result of the second comparison being a second absorption factor, which is determined by dividing the integrated radiant power of the fourth frequency spectrum by the integrated radiant power of the second frequency spectrum.

For example, a first absorption factor of first emitted electromagnetic wave 30 at object 13 of 99% is ascertained as the result of the first comparison, while a second absorption factor of second emitted electromagnetic wave 32 at object 13 of 3% is determined as the result of the second comparison.

In the third comparison, the first absorption factor is now compared to the second absorption factor in the mentioned example, and it is determined that the first absorption factor is greater than the second absorption factor, in particular more than twenty time greater than the second absorption factor and/or that more than 25, which may be more than 50, in particular more than 75 percentage points lie between the first and the second absorption factor. Based upon an evaluation model stored in evaluation device 18, it is possible to determine that object 13 is a metal object on the basis of this result of the third comparison.

The first and/or second frequency spectrum at which first and second electromagnetic wave 30, 32 are able to be emitted may be specified, but may also be adaptable, for instance by a user input or by a situationally generated or received adaptation signal.

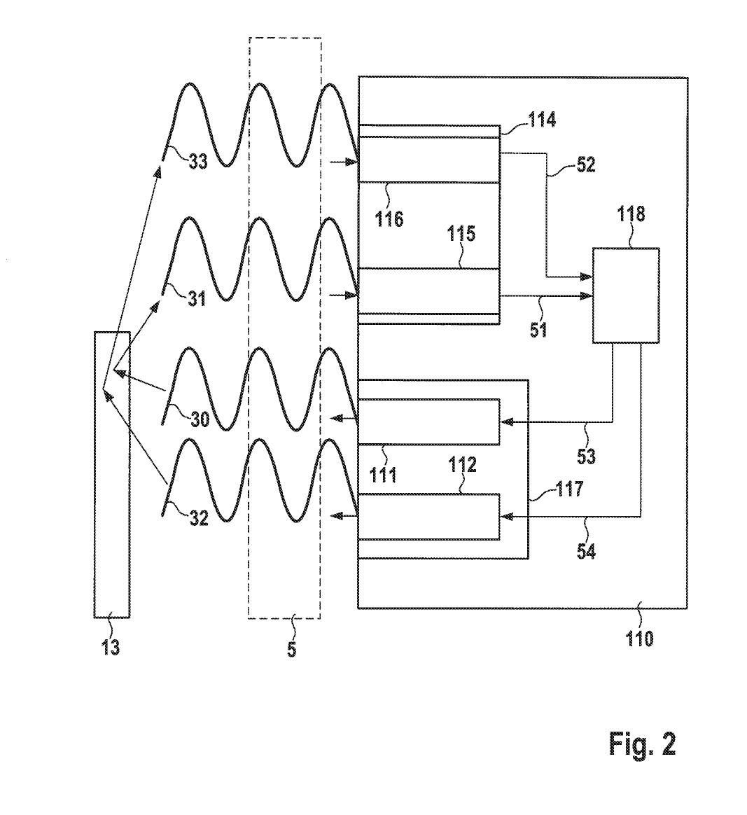

FIG. 2 shows a schematic block circuit diagram of a device 110 for ascertaining a property of an object 13 according to one specific embodiment of the present invention. Device 110 is a variant of device 10. Instead of receiver device 14 of device 10, device 110 is equipped with a receiver device 114, which encompasses a first detector device 115 developed to receive first reflected electromagnetic wave 31 and to generate first measurement signal 51 based on the received first reflected electromagnetic wave 31; it also includes a second detector device 115, which is configured to receive second reflected electromagnetic wave 33 and to generate second measurement signal 52 based on received second reflected electromagnetic wave 33. Device 110 has a transmitter device 117, which encompasses a first transmitter unit 111 for emitting first electromagnetic wave 30 and a second transmitter unit 112 for emitting second electromagnetic wave 32.

In addition, device 110 encompasses an evaluation device 118, which includes the functions of evaluation device 18 and furthermore is configured to generate a first data signal 53 for controlling first transmitter unit 111 and to transmit it to first transmitter unit 111. First transmitter unit 111 is developed to adapt the first frequency spectrum at which first electromagnetic wave 30 is emitted based on received first data signal 53. The first frequency spectrum may be shifted and/or varied within the first frequency range. However, it is also possible to shift the first frequency range, the shifted first frequency range in particular being disjunct from the unshifted, original first frequency range. Using first data signal 53, first transmitter unit 111 in particular may also be controlled to run through the entire first frequency range.

Furthermore, evaluation device 118 is developed to generate a second data signal 54 for controlling second transmitter unit 112 and to transmit the signal to second transmitter unit 112. Second transmitter unit 112 is developed to adapt the second frequency spectrum at which second electromagnetic wave 32 is transmitted based on received second data signal 54. The second frequency spectrum may be shifted and/or varied within the second frequency range. However, it is also possible to shift the second frequency range, the shifted second frequency range in particular being disjunct from the unshifted, original second frequency range. Using second data signal 54, second transmitter unit 112 may in particular also be controlled to run through the entire second frequency range.

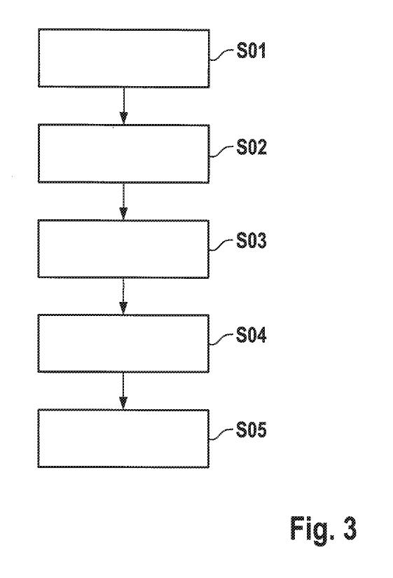

FIG. 3 shows a schematic flow chart in order to explain a method for ascertaining a property of an object 13 according to one specific embodiment of the present invention. The method according to FIG. 3 is suitable for use together with device 10 according to FIG. 1 and may be configured specifically for this purpose. In particular, the method according to FIG. 3 is adaptable according to all variants and further developments of the inventive device described with reference to device 10.

In a step S01, a first electromagnetic wave 30 having a first frequency within a first frequency range is emitted for the at least partial reflection at object 13 as a first reflected electromagnetic wave 31.

In a step S02, a second electromagnetic wave 32 having a second frequency within a second frequency range is emitted for the at least partial reflection at object 13 as a second reflected electromagnetic wave 33. The first and the second frequency range may be disjunct.

In a step S03, a first measurement signal 51 is generated based on received first reflected electromagnetic wave 31. In a step S04, a second measurement signal 52 is generated on the basis of received second reflected electromagnetic wave 33. In a step S05, first and second measurement signals 51, 52 are analyzed in order to ascertain the property of object 13, in particular a material property of object 13.

The method according to FIG. 3 is furthermore suitable for use together with device 110 according to FIG. 2 and may be configured specifically for this purpose. In particular, the method according to FIG. 3 is adaptable according to all variants and further developments of the inventive device described with reference to device 110.

Although the present invention was described above with reference to the exemplary embodiments, it is not limited to such, but may be modified in numerous ways. In particular, the invention can be changed or modified in many ways without deviating from the core of the present invention.

For example, in one specific embodiment, transmitter device 17 according to device 10 may also be combined with receiver device 114 according to device 110. In one specific embodiment, transmitter device 117 according to device 110 may also be combined with receiver device 14 according to device 10.

What is claimed is:

1. A device for ascertaining a property of an object, comprising
a transmitter device, by which a first electromagnetic wave having a first frequency spectrum within a first frequency range is emittable for the at least partial reflection at the object as a first reflected electromagnetic wave, and by which a second electromagnetic wave having a second frequency spectrum within a second frequency range is emittable for the at least partial reflection at the object as a second reflected electromagnetic wave, the first and the second frequency range being disjunct;
a receiver device, by which the first and second reflected electromagnetic waves are receivable and by which a first measurement signal is generatable based on a received first reflected electromagnetic wave, and a second measurement signal is generatable based on a received second reflected electromagnetic wave; and
an evaluation device to ascertain a property of the object based on the first measurement signal and the second measurement signal.

2. The device of claim 1, wherein the first measurement signal indicates a first spectroscopic property of the received first reflected electromagnetic wave, and the second measurement signal indicates a second spectroscopic property of the received second reflected electromagnetic wave, wherein the evaluation device is configured to compare the first spectroscopic property having the first frequency spectrum or a frequency spectrum derived from the first frequency spectrum in a first comparison, and to compare the second spectroscopic property having the second frequency spectrum or a frequency spectrum derived from the second frequency spectrum in a second comparison, and wherein the evaluation device is configured to ascertain the property of the object based on the result of the first and second comparisons.

3. The device of claim 2, wherein the evaluation device is configured to compare the result of the first comparison with the result of the second comparison in a third comparison, and for ascertaining the property of the object based on the result of the third comparison.

4. The device of claim 1, wherein the first frequency range or the second frequency range ranges from 300 gigahertz to 3 terahertz.

5. The device of claim 1, wherein the first frequency range or the second frequency range ranges from 500 megahertz to 100 gigahertz.

6. The device of claim 1, wherein the first electromagnetic wave and the second electromagnetic wave are emittable at the same time.

7. A method for ascertaining a property of an object, the method comprising:
emitting a first electromagnetic wave having a first frequency within a first frequency range for the at least partial reflection at the object as a first reflected electromagnetic wave;
emitting a second electromagnetic wave having a second frequency within a second frequency range for the at least partial reflection at the object as a second reflected electromagnetic wave, the first and the second frequency range being disjunct;
generating a first measurement signal based on a received first reflected electromagnetic wave;
generating a second measurement signal based on a received second reflected electromagnetic wave; and
evaluating the first measurement signal and the second measurement signal to ascertain the property of the object.

8. The method of claim 7, wherein the first measurement signal indicates a first spectroscopic property of the received first reflected electromagnetic wave, and the second measurement signal indicates a second spectroscopic property of the received second reflected electromagnetic wave, and wherein the evaluation of the first measurement signal and the second measurement signal include the following:
comparing, in a first comparison, the first spectroscopic property having the first frequency spectrum or a frequency spectrum derived from the first frequency spectrum; and
comparing, in a second comparison, the second spectroscopic property having the second frequency spectrum or a frequency spectrum derived from the second frequency spectrum, the property of the object being ascertained based on the result of the first comparison and the second comparison.

9. The method of claim 8, wherein the evaluation of the first measurement signal and the second measurement signal includes the following:
comparing, in a third comparison, the result of the first comparison to the result of the second comparison;
wherein the property of the object is ascertained based on the result of the third comparison.

10. The method of claim 7, wherein the first electromagnetic wave and the second electromagnetic wave are emitted at the same time.
